(19) United States
(12) Patent Application Publication
(10) Pub. No.: US 2019/0091864 A1
(43) Pub. Date: Mar. 28, 2019

(54) ROBOT SYSTEM

(71) Applicant: FANUC CORPORATION, Yamanashi (JP)

(72) Inventors: Tetsuro MATSUDAIRA, Yamanashi (JP); Shuu INOUE, Yamanashi (JP)

(21) Appl. No.: 16/137,689

(22) Filed: Sep. 21, 2018

(30) Foreign Application Priority Data
Sep. 27, 2017 (JP) 2017-186278

(51) Int. Cl. B25J 9/16; G05B 19/416

(52) U.S. Cl. CPC B25J 9/1674; G05B 19/416

(57) ABSTRACT

A robot system includes: a robot; a sensor that detects entry of a person into a peripheral region of the robot; and a control device that controls the robot and the sensor. The control device is provided with: a robot control unit that controls the robot; an operating-region prediction unit that sequentially predicts an operating region of the robot up to a predetermined time later; and a detection-region control unit that sets to enabled a detection result of the sensor in a region, of the peripheral region, that includes the operating region, which is predicted by the operating-region prediction unit, and sets to disabled the detection result of the sensor in the other region of the peripheral region. The robot control unit limits the operation of the robot when entry of a person is detected in the region where the detection result of the sensor has been set to enabled.

### CROSS-REFERENCE TO RELATED APPLICATIONS

This application is based on and claims priority to Japanese Patent Application No. 2017-186278, filed on Sep. 27, 2017, the entire content of which is incorporated herein by reference.

### FIELD OF THE INVENTION

The present invention relates to a robot system.

### BACKGROUND OF THE INVENTION

In the related art, there is a known robot system in which a sensor is provided in order to avoid contact between a person and an industrial robot in an environment where the person and the industrial robot coexist and work together (for example, see Japanese Unexamined Patent Application, Publication No. Sho 60-62482). In this robot system, when the sensor detects a positional relationship in which the person and the industrial robot are likely to come into contact with each other, the industrial robot is made to slow down or stop.

### SUMMARY OF THE INVENTION

The present invention provides the following solutions.

One aspect of the present invention is directed to a robot system including: a robot; a sensor that detects entry of a person into a peripheral region of the robot; and a control device that controls the robot and the sensor, wherein the control device is provided with: a robot control unit that controls the robot on the basis of an operation program; an operating-region prediction unit that sequentially predicts an operating region of the robot up to a predetermined time later, on the basis of the operation program; and a detection-region control unit that sets to enabled a detection result of the sensor in a region, of the peripheral region, that includes the operating region, which is predicted by the operating-region prediction unit, and sets to disabled a detection result of the sensor in the other region of the peripheral region; and the robot control unit limits the operation of the robot when entry of a person is detected in the region where the detection result of the sensor has been set to enabled.

### BRIEF DISCUSSION OF THE DRAWINGS

FIG. 1 is a view showing the overall configuration of a robot system according to one embodiment of the present invention.

FIG. 2 is a block diagram showing the robot system shown in FIG. 1.

FIG. 3 is a plan view showing an example position of the robot at time t1 in the robot system shown in FIG. 1.

FIG. 4 is a plan view showing an example position of the robot at time t1+T in the robot system shown in FIG. 1.

FIG. 5 is a plan view showing an example range of area sensors that are set to enabled on the basis of an operating region of the robot predicted at time t1 in the robot system shown in FIG. 1.

FIG. 6 is a plan view showing an example position of the robot at time t1+41 in the robot system shown in FIG. 1.

FIG. 7 is a plan view showing an example position of the robot at time t1+Δt+T in the robot system shown in FIG. 1.

FIG. 8 is a plan view showing an example range of area sensors that are set to enabled on the basis of an operating region of the robot predicted at time t1+Δt in the robot system shown in FIG. 1.

FIG. 9 is a plan view of a modification of the robot system shown in FIG. 1, including an example flow line of a person.

FIG. 10 is a plan view showing example area sensors that are newly set to enabled anew on an extended line of the flow line of the person shown in FIG. 9.

### DESCRIPTION OF EMBODIMENTS OF THE INVENTION

A robot system 1 according to one embodiment of the present invention will be described below with reference to the drawings.

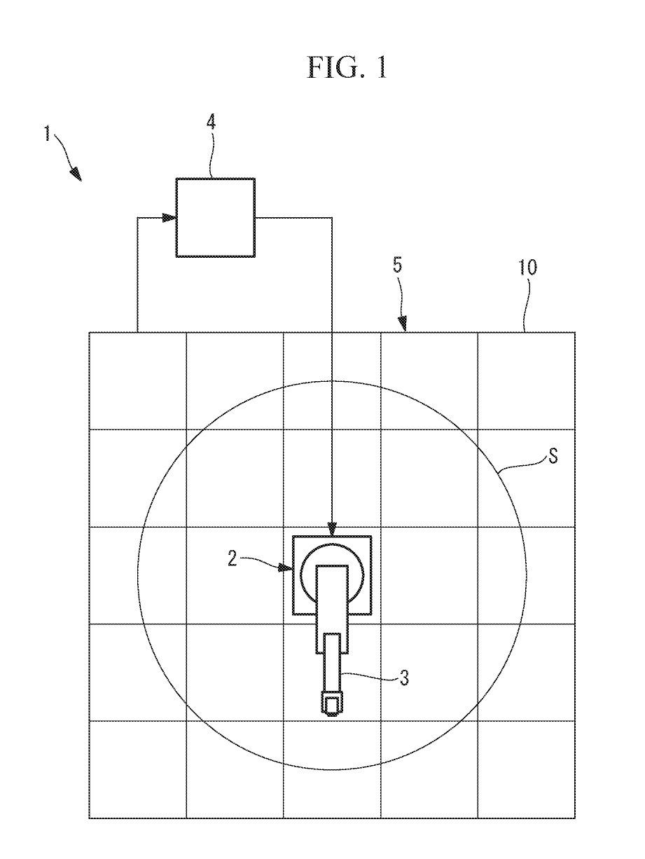

As shown in FIG. 1, the robot system 1 of this embodiment is provided with: a robot 2 that has a range of motion S set in advance according to the axis configuration, the operating angle of each axis, the length of an arm 3, etc.; a control device 4 that controls the robot 2; and a sensor 5 that detects entry of a person into a peripheral region of the robot 2.

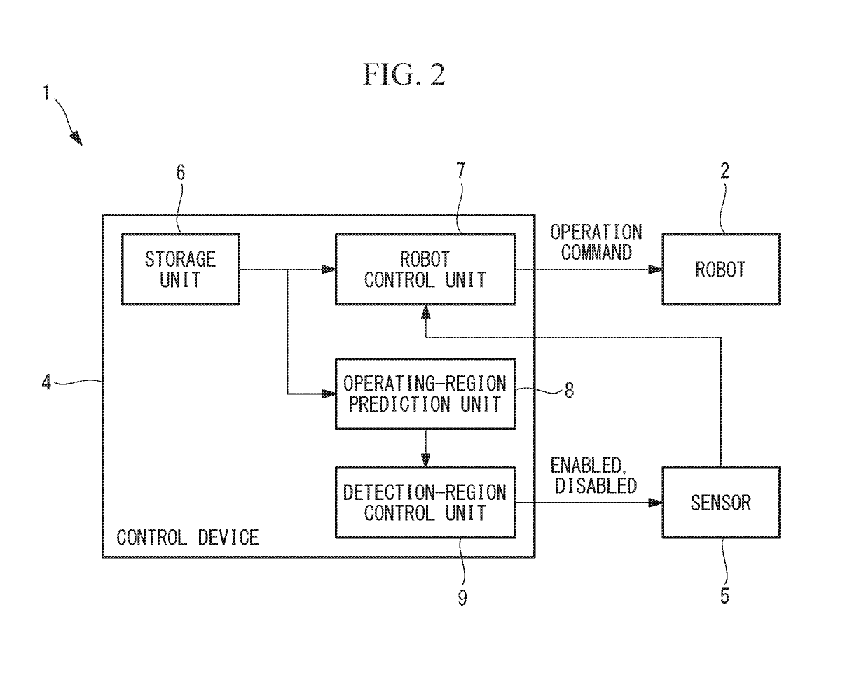

As shown in FIG. 2, the control device 4 is provided with: a storage unit 6, such as a memory, that stores an operation program taught in advance; a robot control unit 7 that controls the robot 2 on the basis of the operation program stored in the storage unit 6; an operating-region prediction unit 8 that sequentially predicts an operating region of the robot 2 up to a predetermined time T later, on the basis of the operation program; and a detection-region control unit 9 that controls a detection region detected by the sensor 5.

The sensor 5 is provided with, for example, 25 square-shaped floor-mat-like area sensors 10 that are spread out on a peripheral floor surface surrounding the robot 2 and detects entry of a person into the region corresponding to the area sensors 10 when any of the area sensors 10 is stepped on by the person. In the sensor 5, each of the area sensors (small regions) 10 can be switched between enabled and disabled, and, if the area sensor 10 is set to enabled, the area sensor 10 can detect entry of a person and outputs a detection signal when stepped on. On the other hand, if the area sensor 10 is set to disabled, the area sensor 10 cannot detect entry of a person and does not output a detection signal even when stepped on.

The operating-region prediction unit 8 predicts, at predetermined time intervals Δt, an operating region of the robot 2 from each time point to the predetermined time T later, on the basis of the operation program. Specifically, at time t1 at which prediction is performed, an operating region of the robot 2 from the time t1 to time t1+T is predicted, and, at time t1+Δt at which prediction is performed, an operating region of the robot 2 from the time t1+Δt to time t1+Δt+T is predicted.

The area sensors 10 that are disposed in a region including the operating region of the robot 2 up to the predetermined time T later, which is detected by the operating-region prediction unit 8, are set to enabled by the detection-region control unit 9, and the other area sensors 10 are set to disabled.

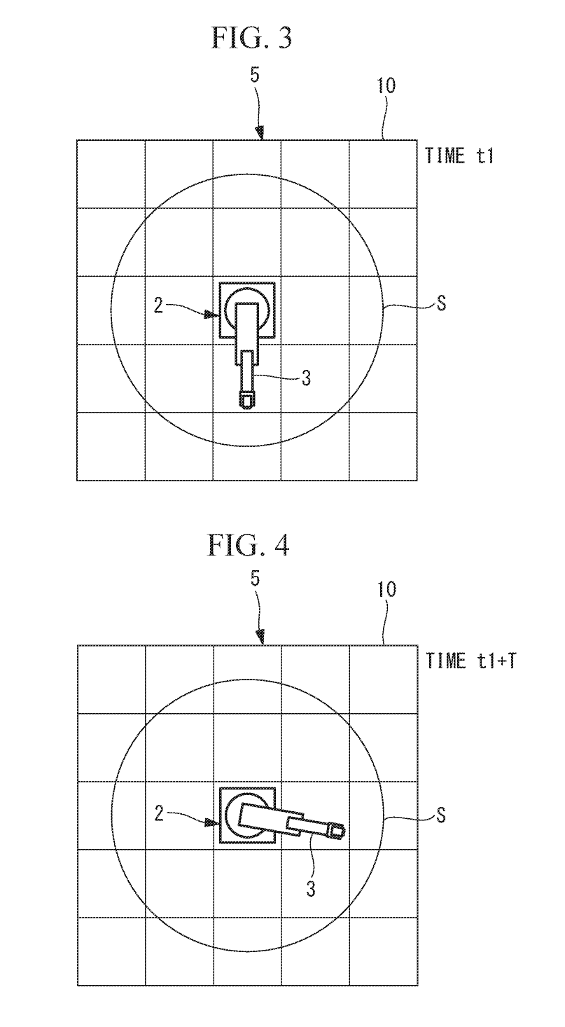

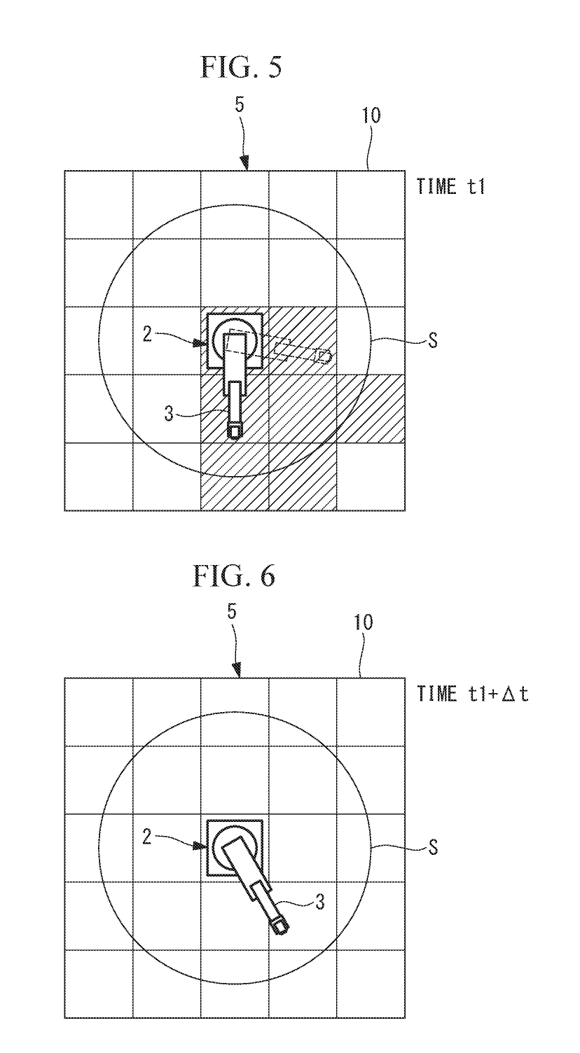

For example, as shown in FIG. 3, at the time t1, in a state in which the robot 2 is disposed at the origin position, the operating-region prediction unit 8 predicts an operating region of the robot 2 up to time t1+T, which is the predetermined time T after time t1, as shown in FIG. 4. If the predicted operating region is a region corresponding to the area sensors 10 that are indicated by diagonal lines in FIG. 5, those area sensors 10 indicated by diagonal lines are set to enabled, and the other area sensors 10 are set to disabled.

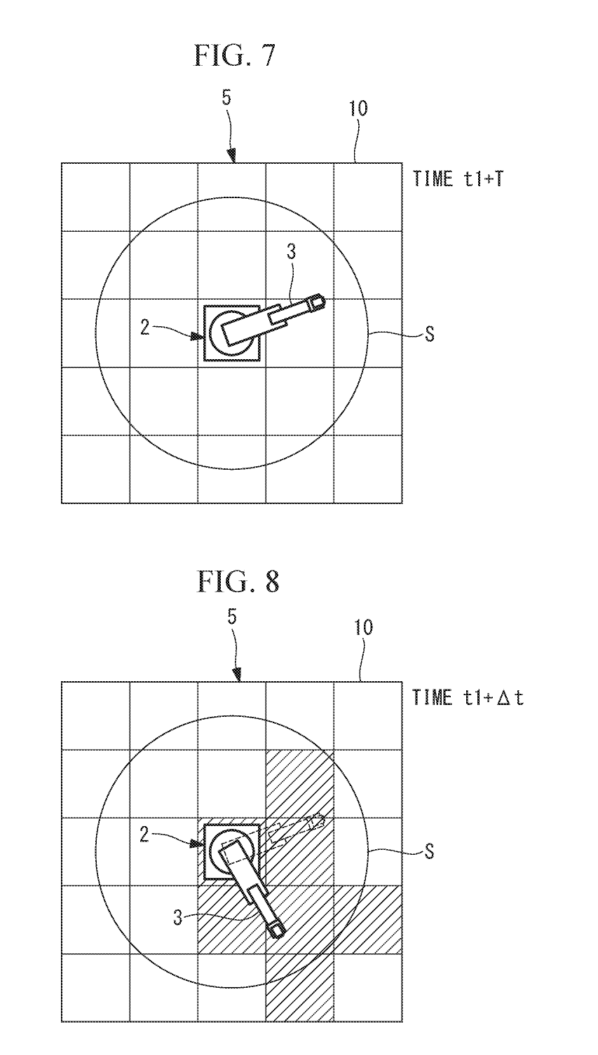

Furthermore, as shown in FIG. 6, at time t1+Δt at which the next prediction is performed, an operating region of the robot 2 from a state in which the robot 2 has been slightly moved from the point of the time t1, to time t1+Δt+T, which is the predetermined time T after the prediction performed by the operating-region prediction unit 8, as shown in FIG. 7, is predicted. If the predicted operating region is a region corresponding to the area sensors 10 that are indicated by diagonal lines in FIG. 8, the settings are switched such that those area sensors 10 indicated by diagonal lines are set to enabled, and the other area sensors 10 are set to disabled.

Then, in this embodiment, when the area sensor 10 that is set to enabled by the detection-region control unit 9 is stepped on by a person, the robot control unit 7 limits the operation of the robot 2. More specifically, the robot control unit 7 outputs an operation command for reducing the operating speed of the robot 2 or for stopping the robot 2.

The operation of the thus-configured robot system 1 of this embodiment will be described below.

According to the robot system 1 of this embodiment, when the operation program, which is taught in advance, is executed by the robot control unit 7, and thus, the robot 2 is operated according to the operation program, the operating-region prediction unit 8 predicts an operating region of the robot 2 up to the predetermined time T later, at predetermined time intervals Δt, the area sensors 10 that correspond to a region including the predicted operating region are set to enabled, and the other area sensors 10 are set to disabled.

Accordingly, when a person is detected by the area sensors 10 that have been set to enabled, the robot control unit 7 limits the operation of the robot 2. Specifically, when entry of a person into a region where it is predicted that the robot 2 is likely to be positioned within the time T after the prediction is detected, the operating speed of the robot 2 is reduced, or the robot 2 is stopped. Accordingly, the possibility of contact between a person and the robot 2 can be reduced.

On the other hand, when a person enters a region for which no possibility of the robot 2 being positioned within the time T after the prediction is predicted, even if the region is located within the range of motion S of the robot 2, because the corresponding area sensors 10 are set to disabled, the entry of the person is not detected, and thus, the operation of the robot 2 is not limited. Accordingly, when the robot 2 is operated in a particular region within the range of motion S, if a person passes through the a region other than that region, the operation of the robot 2 is not limited; therefore, there is an advantage in that it is possible to suppress a reduction in the productivity compared with a case in which the operation of the robot 2 is uniformly limited when a person enters the range of motion S of the robot 2.

Furthermore, according to the robot system 1 of this embodiment, because the sensor 5 is composed of the plurality of floor-mat-like area sensors 10, which are spread out on the floor surface around the robot 2, it is possible to switch the sensor 5 between enabled and disabled in units of small regions corresponding to the area sensors 10. Accordingly, there is an advantage in that it is not necessary to compose regions of the sensor 5 to be set enabled or disabled, in a complicated manner, thus making it possible to easily perform control.

Note that, as the sensor 5, although a description has been given of an example sensor, that is composed of the 5×5=25 floor-mat-like area sensors 10 in this embodiment, instead of this, the sensor may also be composed of an arbitrary number of area sensors 10, e.g. 3×3=9. Furthermore, although the area sensors 10, which perform detection by being stepped on by a person, are shown as example, instead of this, it is also possible to detect a person by using a camera that is installed facing downward at above the robot 2. In this case, it is also possible to divide an image acquired by the camera into a plurality of areas and to make each of the areas function as the area sensor 10, which detects a person in the corresponding area. Then, it is merely necessary to switch the area sensors 10 which have been divided in this way between enabled and disabled.

Furthermore, in this embodiment, although the detection itself of the area sensor 10 is set to enabled or disabled, instead of this, it is also possible to maintain the detection itself of the area sensor 10 in an enabled state and to switch the output detection result between enabled and disabled according to the predicted region. Specifically, the area sensor 10 may always output a detection signal when a person enters therein, and the detection-region control unit 9 may determine whether the detection signal is enabled or disabled.

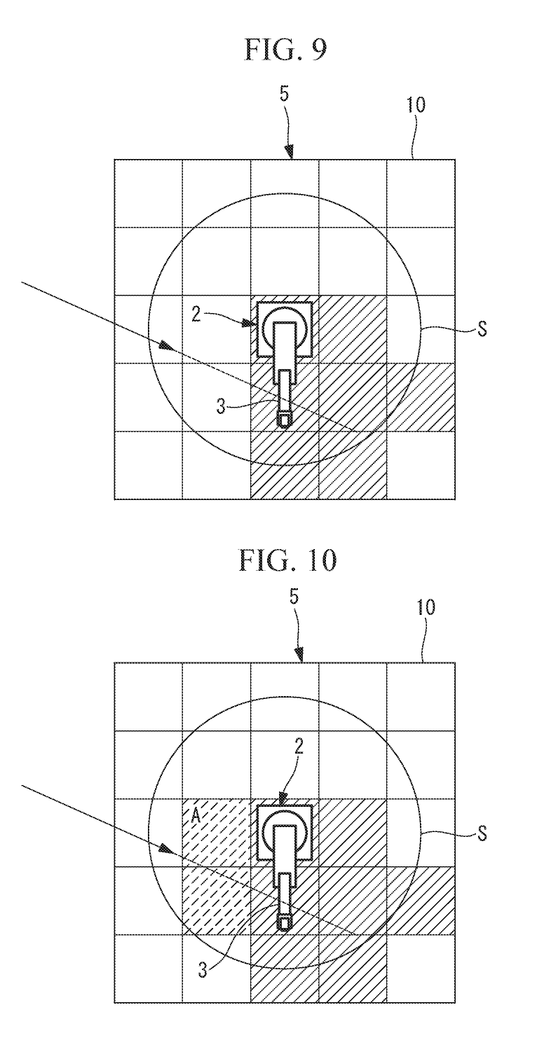

Furthermore, in this embodiment, for example, it is also possible to adopt, as the area sensors 10, a camera that is disposed facing downward above the robot 2 and to be provided with an image processing unit (motion detection unit, not shown) that processes an image acquired by the camera and that detects the flow line of a person and the speed of the person. Then, as shown in FIG. 9, when an extended line of the flow line of the person detected by the image processing unit intersects with a region where the sensor 5 is set to enabled according to the prediction based on the operation program, and the speed of the person detected by the image processing unit is equal to or greater than a predetermined threshold, the detection-region control unit 9 may expand the region where the sensor 5 is set to enabled, toward the person side.

Specifically, for example, in the above example, as shown in FIG. 10, regarding a region A (region indicated by diagonal dashed lines) where the sensor 5 is set to disabled because the region A is not a predicted operating region of the robot 2, the sensor 5 may be set to enabled in the region A due to a high possibility that a person moving at high speed enters the predicted operating region of the robot 2, and, when the person enters the region A, the entry may be detected, and the operating speed of the robot 2 may be reduced. Accordingly, there is an advantage in that, when the person enters the operating region of the robot 2 beyond the region A, it is possible to achieve a state in which the robot 2 can be immediately stopped, and to more effectively suppress interference between the person and the robot 2.

Furthermore, although the flow line and the speed of a person are detected by processing an image acquired by the camera, instead of this, the flow line and the speed of a person may also be detected by the floor-mat-like area sensors 10, which are spread out on the floor surface.

As a result, the above-described embodiment leads to the following aspect.

One aspect of the present invention is directed to a robot system including: a robot; a sensor that detects entry of a person into a peripheral region of the robot; and a control device that controls the robot and the sensor, wherein the control device is provided with: a robot control unit that controls the robot on the basis of an operation program; an operating-region prediction unit that sequentially predicts an operating region of the robot up to a predetermined time later, on the basis of the operation program; and a detection-region control unit that sets to enabled a detection result of the sensor in a region, of the peripheral region, that includes the operating region, which is predicted by the operating-region prediction unit, and sets to disabled a detection result of the sensor in the other region of the peripheral region; and the robot control unit limits the operation of the robot when entry of a person is detected in the region where the detection result of the sensor has been set to enabled.

According to this aspect, the robot is controlled on the basis of the operation program through actuation of the robot control unit, and an operating region of the robot up to a predetermined time later is sequentially predicted by the operating-region prediction unit on the basis of the operation program. Then, in a region, of the peripheral region, that becomes the operating region of the robot until a predetermined time later, because a detection result of the sensor is set to be enabled by the detection-region control unit, the sensor detects entry of a person, and the robot control unit limits the operation of the robot. On the other hand, in a region thereof that does not become the operating region of the robot until a predetermined time later, a detection result of the sensor is set to be disabled by the detection-region control unit.

Here, setting of a detection result of the sensor to disabled includes a case in which detection itself of the sensor is set to be disabled and a case in which, although detection itself of the sensor is enabled, a detection result is treated as disabled.

Specifically, if a person enters a region where the detection result of the sensor has been set to enabled, the robot control unit limits the operation of the robot, thus making it possible to avoid interference between the person and the robot, and, if the person enters, even in the range of motion of the robot, a region that does not become the range of the operation of the robot until a predetermined time later, because the detection result of the sensor is set to disabled, the operation of the robot need not be limited. Then, the operating-region prediction unit sequentially predicts an operating region of the robot, thereby making it possible to sequentially switch between a region where the detection result of the sensor is set to enabled and a region where the detection result of the sensor is set to disabled and to prevent a reduction in the productivity while avoiding interference between the person and the robot.

In the above-described aspect, the peripheral region may be divided into a plurality of small regions; and the detection-region control unit sets a detection result of the sensor to enabled in the small regions that overlap with at least part of the operating region and sets a detection result of the sensor to disabled in the other small regions.

By doing so, in small regions that overlap with at least part of a region that becomes the operation range of the robot until a predetermined time later, the detection result of the sensor is set to enabled by the detection-region control unit, and the detection result of the sensor in the other small regions is set to disabled. Accordingly, it is possible to switch between setting the detection result of the sensor to enabled or disabled in units of small regions. Accordingly, regions in which the detection result of the sensor is set to enabled or disabled can be simply set without being complicated.

Furthermore, the above-described aspect may further comprise a motion detection unit that detects a flow line and a speed of the person in the peripheral region, wherein, when an extended line of the flow line of the person, which is detected by the motion detection unit, intersects with a region that includes the operating region, and the speed of the person is equal to or greater than a predetermined threshold, the detection-region control unit may expand a region where the detection result of the sensor is set to enabled, toward the person detected by the motion detection unit.

By doing so, if the motion detection unit detects the flow line and the speed of the person in the peripheral region, when an extended line of the detected flow line intersects with a region including the operating region of the robot, whether the speed of the person is equal to or greater than the predetermined threshold is determined. When the extended line of the flow line of the person intersects with the region including the operating region of the robot, and the speed of the person is equal to or greater than the predetermined threshold, the detection-region control unit expands the region where the detection result of the sensor is set to enabled, toward the person, thereby making it possible to limit the operation of the robot before the person reaches the region including the operating region of the robot. Accordingly, at the moment when the person moving at high speed enters the operating region of the robot, the robot can be stopped.

According to the present invention, an advantageous effect is afforded in that it is possible to avoid contact between a person and an industrial robot without reducing the productivity.

1. A robot system comprising:
a robot;
a sensor that detects entry of a person into a peripheral region of the robot; and
a control device that controls the robot and the sensor,
wherein the control device is provided with: a robot control unit that controls the robot on the basis of an operation program; an operating-region prediction unit that sequentially predicts an operating region of the robot up to a predetermined time later, on the basis of the operation program; and a detection-region control unit that sets to enabled a detection result of the sensor in a region, of the peripheral region, that includes the operating region, which is predicted by the operating-region prediction unit, and sets to disabled a detection result of the sensor in the other region of the peripheral region; and
the robot control unit limits the operation of the robot when entry of a person is detected in the region where the detection result of the sensor has been set to enabled.

2. The robot system according to claim 1,
wherein the peripheral region is divided into a plurality of small regions; and
the detection-region control unit sets a detection result of the sensor to enabled in the small regions that overlap with at least part of the operating region and sets a detection result of the sensor to disabled in the other small regions.

3. The robot system according to claim 1, further comprising a motion detection unit that detects a flow line and a speed of the person in the peripheral region,
wherein, when an extended line of the flow line of the person, which is detected by the motion detection unit, intersects with a region that includes the operating region, and the speed of the person is equal to or greater than a predetermined threshold, the detection-region control unit expands a region where the detection result of the sensor is set to enabled, toward the person detected by the motion detection unit.
